(19) United States
(12) Patent Application Publication
(10) Pub. No.: US 2009/0058605 A1
(43) Pub. Date: Mar. 5, 2009

(54) WIRELESS RECEPTION DEVICE, WIRELESS SENDING DEVICE, AND WIRELESS TRANSMISSION DEVICE

(75) Inventor: Takashi Taya, Tokyo (JP)

Correspondence Address: Studebaker & Brackett PC, 1890 Preston White Drive, Suite 105, Reston, VA, 20191, US

(73) Assignee: OKI ELECTRIC INDUSTRY CO., LTD., Tokyo (JP)

(21) Appl. No.: 12/170,605

(22) Filed: Jul. 10, 2008

(30) Foreign Application Priority Data
Aug. 30, 2007 (JP) 2007-223966

(51) Int. Cl. H04Q 5/22

(52) U.S. Cl. 340/10.1

(57) ABSTRACT

A wireless reception device, a wireless sending device, and a wireless transmitting device are provided, wherein occurrences of distortion and an error in the radio signal that is being transmitted can be prevented even if compensation for circuit characteristics is performed.

The wireless reception device writes a reception parameter into reception parameter memory means for renewal, only when a predetermined renewal condition is satisfied. The wireless reception device generates a reception characteristic control signal, on the basis of a reception parameter which is stored in the reception parameter memory means. The wireless sending device writes a sending parameter into sending parameter memory means for renewal, only when a predetermined renewal condition is satisfied. The wireless sending device generates a sending characteristic control signal, on the basis of a sending parameter which is stored in sending parameter memory means.

### BACKGROUND OF THE INVENTION

1. Field of the Invention

The present invention relates to a wireless reception device, a wireless sending device and a wireless transmission sending and receiving device, each for generating a parameter and controlling its characteristics on the basis of the generated parameter.

2. Description of the Related Art

In a wireless transmission device for receiving or sending a radio signal, characteristics of the circuit for receiving or sending the radio signal are subjected to change in its characteristics caused by changes in its ambient temperature and its radio signal frequency, etc. Since changes in the circuit characteristics affect reception and sending of the radio signal, compensation for the changes in the circuit characteristics caused by changes in temperature, a radio signal frequency, etc. has been performed.

As such a device for compensating changes in circuit characteristics caused by alterations in the ambient temperature, Japanese Patent Kokai No. 2000-341062 discloses a device for compensating gain variations caused by alteration in the ambient temperature, by serially connecting a plurality of gain control parts each having a gain temperature characteristic varying in accordance with a control signal, and generating the control signal for each of the gain control parts. Japanese Patent Kokai No. 2006-165985 discloses another device for compensating temperature characteristics of a transmission signal generating circuit and a power amplifier circuit, with a temperature compensating circuit of the sending signal generating circuit. Further, Japanese Patent Kokai No. 2001-186083 discloses a device for compensating variations in gain caused by ambient temperature alteration, on the basis of intensity of a reception signal. This device also compensates for variations in gain caused by alterations in frequency on the basis of the intensity of the reception signal.

In the above mentioned devices, compensation for temperature or frequency characteristic has been performed by renewing circuit characteristics such as a gain, as the ambient temperature or a frequency of a wireless radio signal alters. Recently, compensation for temperature or frequency characteristic has been performed by digitally controlling renewal and setting of parameters which determine circuit characteristics. If renewal and setting of parameters are performed by digital control, a value of a parameter becomes discrete. Therefore, the circuit characteristics can change stepwise.

If circuit characteristics change stepwise while receiving or sending a radio signal in a wireless reception device, distortion can be given to the radio signal which is passing through the circuit and distortions or errors may occur in the received radio signal. As temperature or the frequency of a radio signal and so forth alter in the above-mentioned device, the circuit characteristics such as a gain are renewed even while receiving or sending the radio signal. For this reason, distortion or errors may occur in the transmitted radio signal.

### SUMMARY OF THE INVENTION

The present invention has been conceived to solve the above problem. An object of the present invention is to provide a wireless reception device, a wireless sending device and a wireless transmission device which can prevent distortion or errors occurring to the radio signal even if circuit characteristics are changed during operation for compensation.

A wireless reception device according to the present invention is a wireless reception device for generating a reception parameter and controlling its own characteristics on the basis of the generated reception parameter and comprises: reception means for receiving a radio signal by reception characteristics changing in accordance with a reception characteristic control signal; reception parameter generating means for generating the reception parameter; reception parameter memory means for storing the reception parameter; reception parameter writing means for writing the reception parameter which is generated by the reception parameter generating means into the reception parameter memory means for renewal; and reception control means for generating the reception parameter control signal determined by the reception parameter that is stored in the reception parameter memory means, wherein the reception parameter writing means writes a reception parameter into the reception memory means, only when a predetermined renewal requirement of a reception parameter is satisfied.

A wireless sending device according to the present invention is a wireless sending device for generating a sending parameter and controlling its own characteristics on the basis of the generated sending parameter and comprises: sending means for sending a radio signal through sending characteristics changing in accordance with a sending characteristic control signal; sending parameter generating means for generating the sending parameter; sending parameter memory means for storing the sending parameter; sending parameter writing means for writing the sending parameter generated by the sending parameter generating means into the sending parameter memory means for renewal; and sending control means for generating the sending characteristic control signal determined by the sending parameter which is stored in the sending parameter memory means, wherein the sending parameter writing means writes the sending parameter into the sending parameter memory means for renewal, only when a predetermined renewal condition is satisfied.

A wireless transmission device according to the present invention is comprised of: a wireless reception device for generating a reception parameter and controlling its own characteristics on the basis of the generated reception parameter; a wireless sending device for generating a sending parameter and controlling its own characteristics on the basis of the generated sending parameter, wherein the wireless reception device includes: reception means for receiving a radio signal by a reception characteristic changing in accordance with a reception characteristic control signal; reception parameter generating means for generating a reception parameter; reception parameter memory means for storing the reception parameter; reception parameter writing means for writing the reception parameter which is generated by the reception parameter generating means into the reception parameter memory means for renewal; and reception control means for generating a reception characteristic control signal determined by the reception parameter that is stored in the reception parameter memory means, wherein the wireless sending device includes: sending means for sending a radio signal by a sending characteristic changing in accordance with a sending characteristic control signal; sending parameter generating means for generating a sending parameter; sending parameter memory means for storing the sending parameter; sending parameter writing means for writing the sending parameter which is generated by the sending parameter generating means into the parameter memory means for renewal; and sending control means for generating the sending characteristic control signal determined by the sending parameter which is stored in the sending parameter memory means, and wherein the reception parameter writing means writes the reception parameter into the reception parameter memory means for renewal, only when a predetermined renewal condition for the reception parameter is satisfied; and the sending parameter writing means writes the sending parameter into the sending parameter memory means for renewal, only when a predetermined renewal condition for the sending parameter is satisfied.

### BRIEF DESCRIPTION OF THE DRAWINGS

FIG. 1 is a block diagram showing a first embodiment of a wireless transmission device according to the present invention.

FIG. 2 is a sequence diagram showing an operation of the wireless transmission device in FIG. 1.

FIG. 3 is a diagram showing an example of a parameter generating map of the wireless transmission device in FIG. 1.

FIG. 4 is a sequence diagram showing an operation of the wireless transmission device in FIG. 1.

FIG. 5 is a block diagram showing a second embodiment of a wireless transmission device according to the present invention.

FIG. 6 is a sequence diagram showing an operation of the wireless transmission device in FIG. 5.

FIG. 7 is a sequence diagram showing an operation of the wireless transmission device in FIG. 5.

### DETAILED DESCRIPTION OF THE INVENTION

Some embodiments of the present invention will be described in detail hereinafter with reference to the drawings.

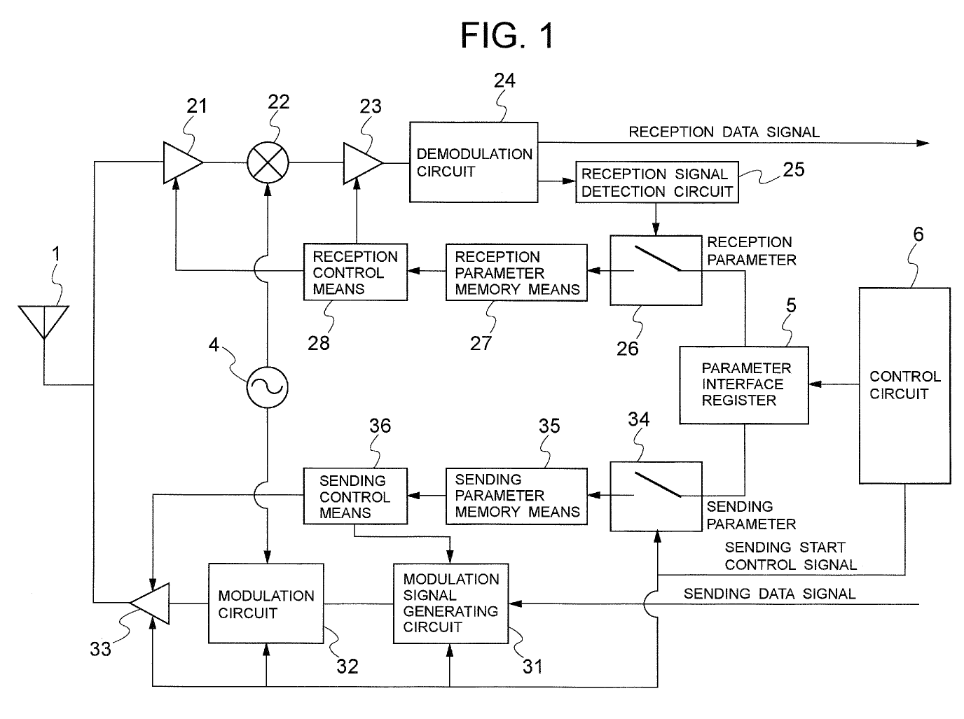

FIG. 1 shows a first embodiment of a wireless transmission device according to the present invention. The wireless transmission device performs a demodulating process of a radio signal which is received by an antenna 1, and outputs a reception data signal wherein the radio signal has been demodulated. Moreover, the wireless transmission device modulates a sending data signal which is input, and outputs it as a radio signal from an antenna 1.

A high-frequency circuit 21 amplifies the radio signal which has been received by the antenna 1, by a gain corresponding to a reception characteristic control signal from reception control means 28. A frequency conversion circuit 22 converts a frequency band of the radio signal which is amplified by the high-frequency circuit 21 into an intermediate-frequency band. An intermediate-frequency circuit 23 amplifies the radio signal which is converted into the intermediate-frequency band by the frequency conversion circuit 22, by a gain corresponding to the reception characteristic control signal from the reception control means 28. A demodulation circuit 24 performs a demodulating process of the radio signal which is amplified by the intermediate-frequency circuit 23, and outputs a reception data signal by which the radio signal is demodulated. Also, reception means is comprised of: the high-frequency circuit 21, the frequency conversion circuit 22, the intermediate frequency circuit 23 and the demodulation circuit 24.

A reception signal detection circuit 25 determines intensity of a reception data signal which is output from the demodulation circuit 24, and judges whether or not there is the reception signal. If the intensity of the reception data signal goes beyond a predetermined threshold value level of e.g. “−90 dBm,” a judgment “Reception Signal Detected” will be made. If the intensity of the reception data signal is below the predetermined value level, a judgment “No Reception Signal Detected” will be made. And the reception signal detection circuit 25 outputs a judgment result regarding the presence of the reception signal. A judgment “Reception Signal Detected” corresponds to a case where the radio signal is being received. A judgment “No Reception Signal Detected” corresponds to a case where the radio signal is not being received.

A switch 26 performs its on or off operation in response to an output of the reception signal detection circuit 25. If an output of the reception signal detection circuit 25 is “Reception Signal Detected,” the switch 26 keeps it “Open.” If an output of the reception signal detection circuit 25 is “No Reception Signal Detected,” the switch 26 keeps it “Closed.” When the switch 26 is in a state of “Closed,” one or more reception parameters which are stored in a parameter interface register 5 are written into reception parameter memory means 27 for renewal (i.e. to renew the reception parameters). When the switch 26 is in a state of “Open,” the reception parameters which are stored in the parameter interface register 5 are not written into the reception parameter memory means 27 for renewal. Reception parameter writing means is comprised of the switch 26 in this embodiment.

The reception parameter memory means 27 stores the reception parameters. Reception control means 28 generates a reception characteristic control signal on the basis of the reception parameters which are stored in the reception parameter memory means 27.

A modulation signal generating circuit 31 generates a modulation signal on the basis of a sending data signal and a sending characteristic control signal from sending control means 36. A modulation circuit 32 performs a modulating process of a modulation signal which is generated by the modulation signal generating circuit 31. An output amplifying circuit 33 amplifies a modulation signal which the modulation circuit 32 modulates, by a gain corresponding to the sending characteristic control signal issued from the sending control means 36. A signal amplified by the output amplifying circuit 33 is output as a radio signal from the antenna 1. Sending means is comprised of the modulation signal generating circuit 31, the modulation circuit 32 and the output amplifying circuit 33 in this embodiment.

A switch 34 performs its on or off operation in response to a sending start control signal from a control circuit 6. If the sending start control signal indicates “Start Sending,” the switch 34 keeps it “Open.” If the sending start control signal indicates “Stop Sending,” the switch 34 keeps it “Closed.” When the switch 34 is in a state of “Closed,” the sending parameters which are stored in the parameter interface register 5 are written into sending parameter memory means 35 for renewal. When the switch 34 is in a state of “Open,” one or more sending parameters which are stored in the parameter interface register 5 are not written into the sending parameter memory means 35 for renewal. The sending start control signal of “Start Sending” corresponds to a case where a radio signal is being sent. The sending start control signal being “Stop Sending,” corresponds to a case where a radio signal is not being sent. Sending parameter writing means is comprised of the switch 34 in this embodiment.

The sending parameter memory means 35 stores the sending parameters. The sending control means 36 generates a sending characteristic control signal on the basis of the sending parameters which are stored in the sending parameter memory means 35.

A local oscillator circuit 4 generates a frequency signal at a frequency which will be required for a frequency conversion process and a modulation process, and outputs the signal to the frequency conversion circuit 22 and the modulation circuit 32. The parameter interface register 5 stores a reception parameter and a sending parameter which the control circuit 6 generates. The control circuit 6 generates the reception parameter and sending parameter, and controls a whole wireless transmission device. The reception parameter generating means and the sending parameter generating means are comprised of the control circuit 6 in this embodiment.

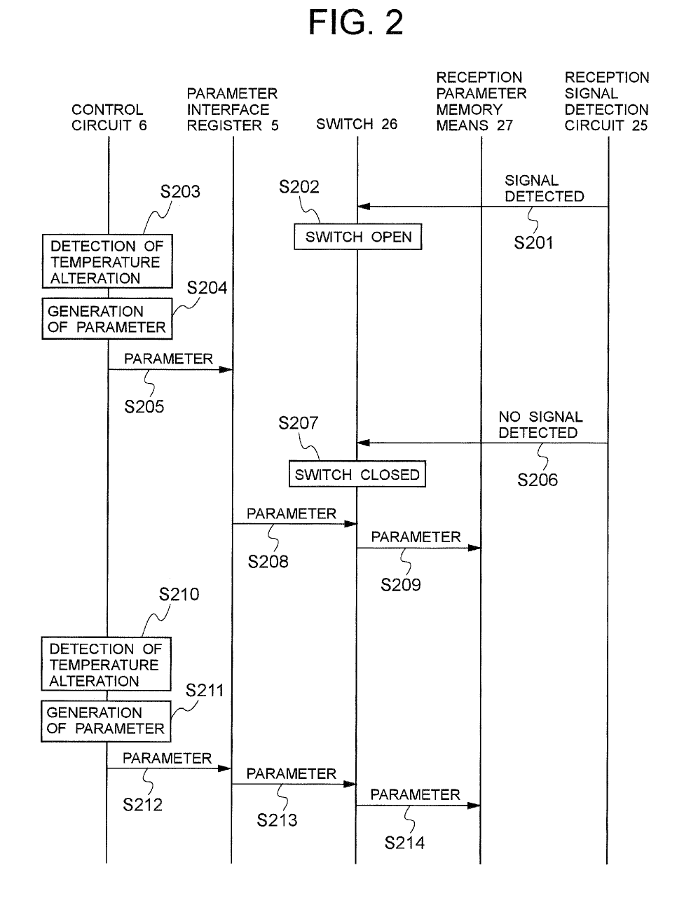

FIG. 2 shows an operation of the wireless transmission device for compensating gain variations caused by the temperature alteration.

For example, a radio signal is received by the antenna 1, and an operation for receiving the radio signal is started in the wireless transmission device. In this case, the reception signal detection circuit 25 determines an intensity of a reception data signal which is output from the demodulation circuit 24, confirms that the intensity goes beyond a predetermined threshold value, and outputs a judgment “Reception Signal Detected” (step S201). When the judgment “Reception Signal Detected” is output from the reception signal detection circuit 25, the switch 26 keeps it “Open” (step S202). When the switch 26 is in a state of “Open,” one or more reception parameters which are stored in the parameter interface register 5 are not written into the reception parameter memory means 27 for renewal.

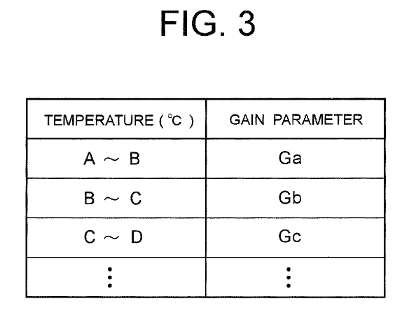

For example, temperature alters, and a gain value is required to change. In this case, the control circuit 6 generates a reception parameter which corresponds to the altered temperature (step S204). Generation of the reception parameter will be performed in accordance with, for example, a parameter generating map shown in FIG. 3. The parameter generating map has description of gain parameter values per various temperature ranges. The control circuit 6 searches a temperature range of the parameter generating map in which the present temperature may belong to, retrieves a gain parameter value which corresponds to the temperature range in which the present temperature belongs to, and sets a retrieved value of the gain parameter as a value of the reception parameter. The parameter generating map is stored in the control circuit 6.

After generating a reception parameter, the control circuit 6 writes the generated reception parameter into the parameter interface register 5 (step S205). Since the switch 26 is in a state of “Open” at this point, the reception parameter written into the parameter interface register 5 is not written into the reception parameter memory means 27 for renewal.

For example, an operation for receiving a radio signal in the wireless transmission device is completed. In this case, the reception signal detection circuit 25 determines intensity of a reception data signal which is output from the demodulation circuit 24, confirms that the intensity is below a predetermined threshold value, and outputs a judgment “No Reception Signal Detected” (step S206). When the judgment result “No Reception Signal Detected” is output from the reception signal detection circuit 25, the switch 26 keeps it “Closed” (step S207). When the switch 26 is in a state of “Closed,” a reception parameter stored in the parameter interface register 5 is written into the reception parameter memory means 27 for renewal (steps S208 and S209). After that, the reception control means 28 generates a reception characteristic control signal for controlling gains of the high-frequency circuit 21 and the intermediate-frequency circuit 23, on the basis of the reception parameter that is generated in the process of S204. This will lead to amplify by a gain corresponding to the temperature alteration which occurred in the process of S203.

For example, temperature alters again, and a gain value is required to change (step S210). In this case, the control circuit 6 generates a reception parameter which corresponds to the altered temperature (step S211). After generating a reception parameter, the control circuit 6 writes the generated reception parameter into the parameter interface register 5 (step S212). Since the switch 26 is in a state of “Closed” at this point, the reception parameter written into the parameter interface register 5 is written into the reception parameter memory means 27 for renewal (steps S213 and S214). After that, the reception control means 28 generates a reception characteristic control signal for controlling gains of the high-frequency circuit 21 and the intermediate-frequency circuit 23, on the basis of the reception parameter that is generated in the process of S211. This will lead to amplify by a gain corresponding to the temperature alteration which occurred in the process of S210.

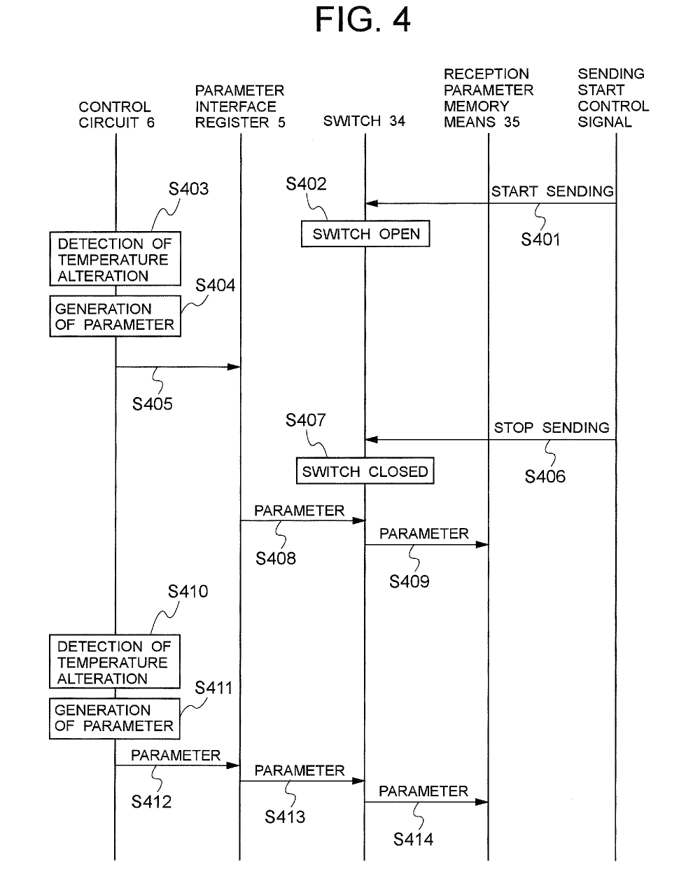

FIG. 4 shows an operation of the wireless transmission device for compensating variations in gain caused by the temperature alteration.

For example, the sending start control signal indicates “Start Sending” (step S401), an operation for sending a radio signal is started in the wireless transmission device. If the sending start control signal indicates “Start Sending,” the switch 34 keeps it “Open” (step S402). When the switch 34 is in a state of “Open,” a sending parameter stored in the parameter interface register 5 is not written into the sending parameter memory means 35 for renewal (i.e. to renew the sending parameter).

For example, the temperature alters, and a gain value is required to change (step S403). In this case, the control circuit 6 generates a sending parameter which corresponds to the altered temperature (step S404). Generation of the sending parameter is performed in accordance with, for example, the parameter generating map shown in FIG. 3. The parameter generating map has description of gain parameter values per various temperature ranges. The control circuit 6 searches a temperature range of the parameter generating map in which the present temperature may belong to, retrieves a gain parameter value which corresponds to the temperature range in which the present temperature belongs to, and sets a retrieved value of the gain parameter as a value of the sending parameter.

After generating a sending parameter, the control circuit 6 writes the generated sending parameter into the parameter interface register 5 (step S405). Since the switch 34 is in a state of “Open” at this point, the sending parameter written into the parameter interface register 5 is not written into the sending parameter memory means 35 for renewal.

For example, a sending start control signal indicates “Stop Sending” (step S406), and an operation for sending a radio signal is completed in the wireless transmission device. If the sending start control signal indicates “Stop Sending,” the switch 34 keeps it “Closed” (step S407). When the switch 34 is in a state of “Closed,” a sending parameter stored in the parameter interface register 5 is written into the sending parameter memory means 35 for renewal (steps 408 and 409). After that, the sending control means 36 generates the sending characteristic control signal for controlling gains of the modulation signal generating circuit 31 and the output amplifying circuit 33, on the basis of the sending parameter generated in the process of S404. This will lead to amplify by a gain corresponding to the temperature alteration which occurred in the process of step S403.

For example, temperature alters again, and a gain value is required to change (step 410). In this case, the control circuit 6 generates a sending parameter which corresponds to the altered temperature (step S411). After generating a sending parameter, the control circuit 6 writes the generated sending parameter into the parameter interface register 5 (step S412). Since the switch 34 is in a state of “Closed” at this point, the sending parameter written into the parameter interface register 5 is written into the sending parameter memory means 35 for renewal (steps S413 and S414). After that, the sending control means 36 generates the sending characteristic control signal for controlling gains of the modulation signal generating circuit 31 and the output amplifying circuit 33, on the basis of the sending parameter generated in the process of S411. This will lead to amplify by a gain corresponding to the temperature alteration which occurred in the process of S410.

Thus, according to the wireless transmission device in the first embodiment, the reception parameter is written into the reception parameter memory means 27 for renewal, only when a judgment “No Reception Signal Detected” is output from the reception signal detection circuit 25, in other words, only when the radio signal is not being received. Therefore, while receiving the radio signal, the reception parameter which is stored in the reception parameter memory means 27 remains unchanged, and the reception characteristic control signal remains unchanged. Since the reception characteristic control signal remains unchanged, reception characteristics such as a gain remain unchanged. Therefore, the radio signal which is being received is not distorted.

Also, the sending parameter is written into the sending parameter memory means 35 for renewal, only when the sending start control signal indicates “Stop Sending,” in other words, only when the radio signal is not being sent. Therefore, while sending the radio signal, the sending parameter which is stored in the sending parameter memory means 27 remains unchanged, and the sending characteristic control signal remains unchanged. Since the sending characteristic control signal remains unchanged, sending characteristics such as a gain remain unchanged. Therefore, the radio signal which is being sent is not distorted.

Although the operation for compensating gain variations caused by temperature alteration has been explained herein, compensation for variation in circuit characteristics may be performed, on the basis of change of time or that of a reception signal level. Although the operation for compensating gain variations has been explained herein, compensation for variations such as an offset value, a frequency characteristic and a delay characteristic may be performed. Although a composition of a single super-heterodyne method is presented as a part that receives a radio signal in the wireless transmission device herein. However, a straight method, a double super-heterodyne method, a triple super-heterodyne method and so forth may be used.

A second embodiment of the present invention will be explained hereinbelow.

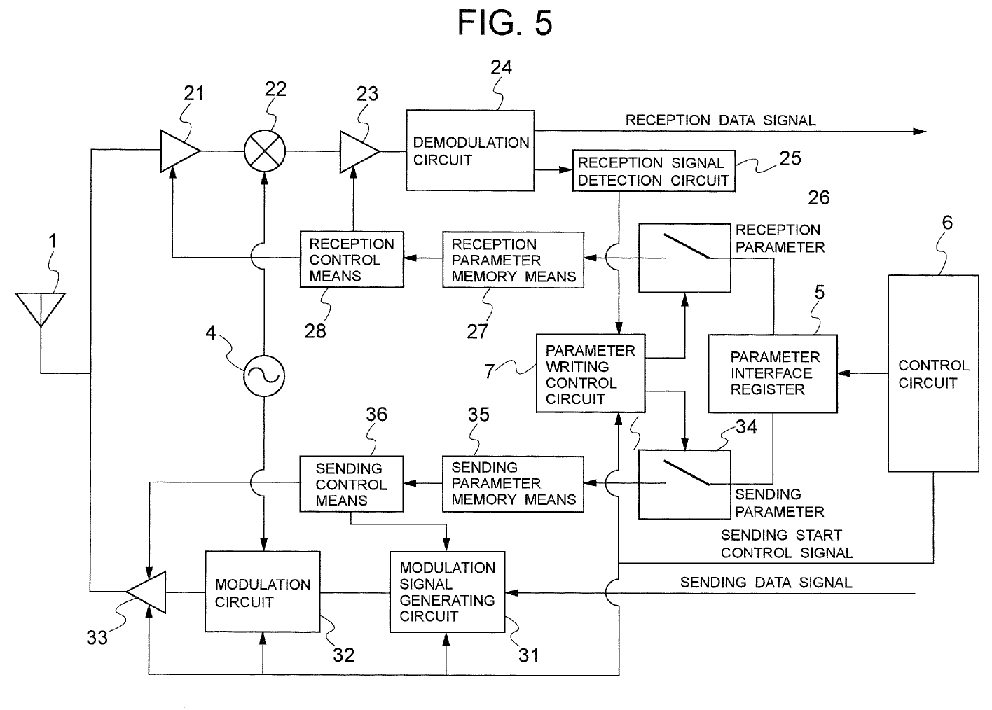

FIG. 5 shows the second embodiment of the wireless transmission device according to the present invention. The wireless transmission device performs a demodulating process of a radio signal which is received by an antenna 1, and outputs a received data signal, with the radio signal demodulated. Further, the wireless transmission device modulates the sending data signal which is output, and outputs it as a radio signal from the antenna 1.

A high-frequency circuit 21 amplifies the radio signal that the antenna 1 receives, by a gain corresponding to a reception characteristic control signal issued from reception control means 28. A frequency converting circuit 22 converts a frequency band of the radio signal that is amplified by the high-frequency circuit 21 into an intermediate-frequency band. An intermediate frequency circuit 23 amplifies the radio signal the frequency band of which is converted into the intermediate frequency band by the frequency converting circuit 22, by a gain corresponding to the reception characteristic control signal from the reception control means 28. A demodulation circuit 24 performs a demodulating process of the radio signal which is amplified by the intermediate-frequency circuit 23, and outputs the reception data signal, with the radio signal demodulated. Reception means is comprised of the high-frequency circuit 21, the frequency converting circuit 22, the intermediate-frequency circuit 23 and the demodulation circuit 24.

A reception signal detection circuit 25 determines intensity of a reception data signal which is output from the demodulation circuit 24, and judges whether or not there is the reception signal. If the intensity of the reception data signal goes beyond a predetermined value of e.g. “−90 dBm,” a judgment “Reception Signal Detected” will be made. If the intensity of the reception data signal is below the predetermined value level, a judgment “No Reception Signal Detected” will be made. The reception signal detection circuit 25 outputs a judgment result regarding the presence of the reception signal.

A switch 26 performs its on or off operation, in accordance with a reception parameter writing control signal from a parameter writing control circuit 7. If the reception parameter writing control signal indicates “Write Prohibited,” the switch 26 keeps it “Open.” If the reception parameter writing control signal indicates “Write Permitted,” the switch 26 keeps it “Closed.” When the switch 26 is in a state of “Closed,” one or more reception parameters stored in a parameter interface register 5 are written into reception parameter memory means 27 for renewal. When the switch 26 is in a state of “Open,” the reception parameters stored in the parameter interface register 5 are not written into the reception parameter memory means 27 for renewal (i.e. to renew the reception parameters). Reception parameter writing means is comprised of the switch 26 and the parameter writing control circuit 7.

The reception parameter memory means 27 stores a reception parameter. The reception control means 28 generates the reception characteristic control signal determined by the reception parameter which is stored in the reception parameter memory means 27.

A modulation signal generation circuit 31 generates a modulation signal on the basis of the sending data signal and a sending characteristic control signal from sending control means 36. A modulation circuit 32 performs a modulation process of the modulation signal which is generated by the modulation signal generating circuit 31. An output amplifying circuit 33 amplifies the modulation signal which is modulated by the modulation circuit 32, by a gain corresponding to the sending characteristic control signal from the sending control means 36. A signal which the output amplifying circuit 33 has amplified is output as a radio signal 1 from the antenna. Sending means is comprised of the modulation signal generating circuit 31, the modulation circuit 32 and the output amplifying circuit 33.

A switch 34 performs its on or off operation, in accordance with a sending parameter writing control signal from the parameter writing control circuit 7. If the sending parameter writing control signal indicates “Write Prohibited,” the switch 34 keeps it “Open.” If the sending parameter writing control signal indicates “Write Permitted,” the switch 34 keeps it “Closed.” When the switch 34 is in a state of “Closed,” one or more sending parameters stored in the parameter interface register 5 are written into sending parameter memory means 35 for renewal (i.e. to renew the sending parameters). When the switch 34 is in a state of “Open,” the sending parameters stored in the parameter interface register 5 are not written into the sending parameter memory means 35 for renewal. Sending parameter writing means is comprised of the switch 34 and the parameter writing control circuit 7.

The sending parameter memory means 35 stores a sending parameter. The sending control means 36 generates a sending characteristic control signal determined by the sending parameter which is stored in the sending parameter memory means 35.

A local oscillator circuit 4 generates a frequency signal at a frequency which will be required for a frequency conversion process and a modulation process, and outputs the signal to the frequency conversion circuit 22 and the modulation circuit 32. The parameter interface register 5 stores a reception and sending parameters which are generated by the control circuit 6. The control circuit 6 generates the reception parameter and the sending parameter, and controls the whole wireless transmission device. Reception parameter generating means and sending parameter generating means are comprised of the control circuit 6.

The parameter writing control circuit 7 generates a reception parameter writing control signal, and controls writing of a reception parameter for renewal from the parameter interface register 5 to the reception parameter memory means 27. The parameter writing control circuit 7 also generates a sending parameter writing control signal, and controls writing of the sending parameter for renewal from the parameter interface register 5 to the sending parameter memory means 35. The parameter writing control circuit 7 sets the reception parameter writing control signal to “Write Permitted,” only when a predetermined renewal requirement of a reception parameter, for example, a requirement that an output of the reception signal detection circuit 25 is “No Reception Signal,” is satisfied. If the predetermined renewal requirement of a reception parameter is not satisfied, the parameter writing control circuit 7 sets the reception parameter writing control signal to “Write Prohibited.” The parameter writing control circuit 7 also set the sending parameter writing control signal to “Write Permitted,” only when a predetermined renewal requirement of a sending parameter, for example, a requirement that a sending start control signal which is output from the control circuit 6 indicates “Stop Sending,” is satisfied. If the predetermined renewal requirement of a sending parameter is not satisfied, the parameter writing control circuit 7 sets the sending parameter writing control signal to “Write Prohibited.”

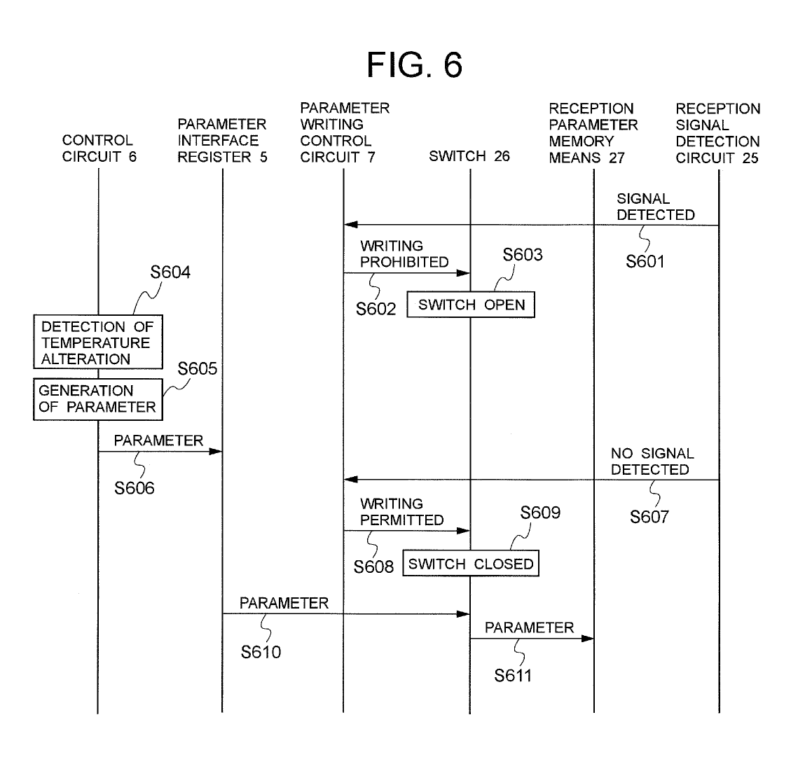

FIG. 6 shows an operation of the wireless transmission device for compensating gain variations caused by temperature alteration.

For example, a radio signal is received from the antenna 1, and an operation for receiving the radio signal is started in the wireless transmission device. In this case, the reception signal detection circuit 25 determines intensity of a reception data signal which is output from the demodulation circuit 24, confirms that the intensity goes beyond a predetermined threshold value, and outputs a judgment result “Reception Signal Detected” (step S601). When the judgment result “Reception Signal Detected” is output from the reception signal detection circuit 25, the parameter writing control circuit 7 sets the reception parameter writing controlling signal to “Write Prohibited” (step S602). When the reception parameter writing control signal indicates “Write Prohibited,” the switch 26 keeps it “Open” (step S603). When the switch 26 is in a state of “Open,” one or more reception parameters stored in the parameter interface register 5 are not written into the reception parameter memory means 27 for renewal.

For example, a temperature alters, and a gain value is required to change (step S604). In this case, the control circuit 6 generates a reception parameter which corresponds to the altered temperature (step S605). Generation of a reception parameter is performed in accordance with, for example, a parameter generating map shown in FIG. 3. The parameter generating map has description of gain parameter values per various temperature ranges. The control circuit 6 searches a temperature range of the parameter generating map in which the present temperature may belong to, retrieves a gain parameter value which corresponds to the temperature range in which the present temperature belongs to, and sets the retrieved value of the gain parameter as a value of the reception parameter. The parameter generating map is stored in the control circuit 6.

After generating a reception parameter, the control circuit 6 writes the generated reception parameter into the parameter interface register 5 (step S606). Since the switch 26 is in a state of “Open” at this point, the reception parameter written into the parameter interface register 5 is not written into the reception parameter memory means 27 for renewal.

For example, an operation for receiving a radio signal is completed in the wireless transmission device. In this case, the reception signal detection circuit 25 determines intensity of a reception data signal which is output from the demodulation circuit 24, confirms the intensity is below a predetermined threshold value, and outputs a judgment result “No Reception Signal Detected” (step S607). When the judgment result “No Reception Signal Detected” is output from the reception signal detection circuit 25, the parameter writing control circuit 7 sets the reception parameter writing control signal to “Write Permitted” (step S608). When the reception parameter writing control signal indicates “Write Permitted,” the switch 26 keeps it “Closed” (step S609). When the switch is in a state of “Closed,” a reception parameter stored in the parameter interface register 5 is written into the reception parameter memory means 27 for renewal (steps S610 and S611). After that, the reception control means 28 generates a reception characteristic control signal for controlling gains of the high-frequency circuit 21 and the intermediate-frequency circuit 23, on the basis of the reception parameter which is generated in the process of step S605. This will lead to amplify by a gain corresponding to the temperature alteration which occurred in the process of step S604.

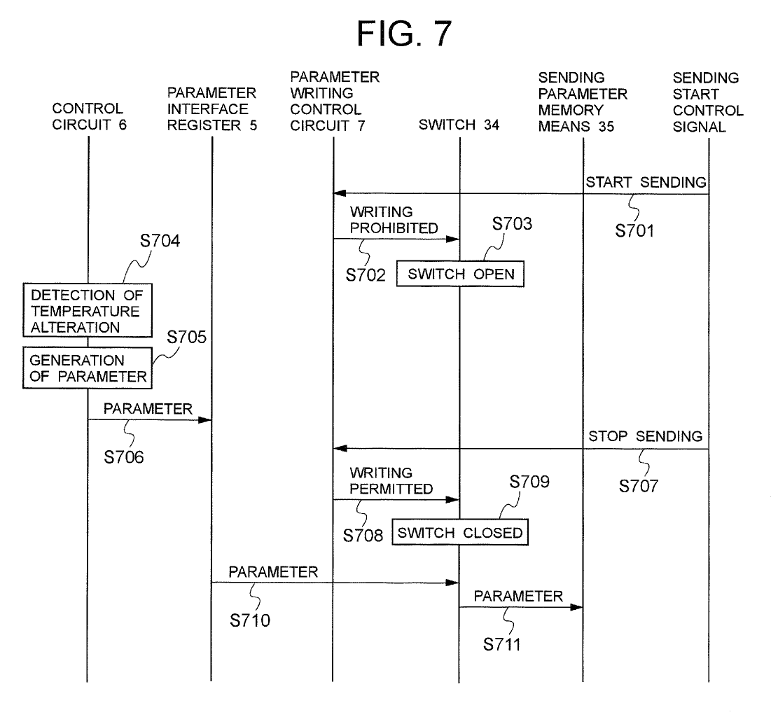

FIG. 7 shows an operation of the wireless transmission device for compensating gain variations caused by temperature alteration.

For example, a sending start control signal indicates “Start Sending” (step S701), and an operation for sending a radio signal is started in the wireless transmission device. If the sending start control signal indicates “Start Sending,” the parameter writing control circuit 7 sets the sending parameter control signal to “Write Prohibited” (step S702). If the sending parameter writing control signal indicates “Write Prohibited,” the switch 34 keeps it “Open” (step S703). If the switch 34 is in a state of “Open,” a reception parameter stored in the parameter interface register 5 is not written into the sending parameter memory means 35 for renewal.

For example, temperature alters, and a gain value is required to change (step S704). In this case, the control circuit 6 generates a sending parameter which corresponds to the altered temperature (step S705). Generation of the sending parameter is performed in accordance with, for example, a parameter generating map shown in FIG. 3. The parameter generating map has description of gain parameter values per various temperature ranges. The control circuit 6 searches a temperature range of the parameter generating map in which the present temperature may belong to, retrieves a gain parameter value which corresponds to the temperature range in which the present temperature belongs to, and sets a retrieved value of the gain parameter as a value of the sending parameter. The parameter generating map is stored in the control circuit 6.

After generating the sending parameter, the control circuit 6 writes the generated sending parameter into the parameter interface register 5 (step S706). Since the switch 34 is in a state of “Open” at this point, the sending parameter written into the parameter interface register 5 is not written into the sending parameter memory means 35 for renewal.

For example, a sending start control signal indicates “Stop Sending” (step S707), and an operation for sending a radio signal is completed in the wireless transmission device. If the sending start control signal indicates “Stop Sending,” the parameter writing control circuit 7 sets the sending parameter writing control signal to “Write Permitted” (step S708). If the sending parameter writing control signal indicates “Write Permitted,” the switch 34 keeps it “Closed” (step S709). If the switch 34 is in a state of “Closed,” a sending parameter stored in the parameter interface register 5 is written into the sending parameter memory means 35 for renewal (steps S710 and S711). After that, the sending control means 36 generates a sending characteristic control signal for controlling gains of the modulating signal generating circuit 31 and the output amplifying circuit 33, on the basis of the sending parameter generated in the process of step S705. This will lead to amplify by a gain corresponding to the temperature alteration which occurred in the process of step S704.

Thus, according to the wireless transmission device in the second embodiment, the reception parameter is written into the reception parameter memory means 27 for renewal, only when a predetermined renewal condition for the reception parameter, in other words, a requirement that an output of the reception signal detection circuit 25 is “No Reception Signal Detected,” is satisfied. Therefore, while receiving the radio signal, the reception parameter which is stored in the reception parameter memory means 27 remains unchanged, and the reception characteristic control signal remains unchanged. Since the reception characteristic control signal remains unchanged, reception characteristics such as a gain remain unchanged. Therefore, the radio signal which is being received is not distorted.

Also, the sending parameter is written into the sending parameter memory means 35 for renewal, only when a predetermined renewal condition for the sending parameter, in other words, a requirement that the sending start control signal indicates “Stop Sending,” is satisfied. Therefore, while sending the radio signal, the sending parameter which is stored in the sending parameter memory means 35 remains unchanged, and the sending characteristic control signal remains unchanged. Since the sending characteristic control signal remains unchanged, sending characteristics such as a gain remain unchanged. Therefore, the radio signal which is being sent is not distorted.

Herein, the renewal of the reception parameter and the sending parameter which is an interval between the previous and the new renewal may be made longer than a minimum renewal interval measured by a timer provided in the parameter writing control circuit 7, so as to prevent excess renewal of parameters.

Also, the operation for compensating gain variations caused by the temperature alteration has been explained herein. However, compensation for a variation of circuit characteristics may be performed, on the basis of change of time or that of a reception signal level. The circuit characteristics for compensation may be an offset value, a frequency characteristic, a delay characteristic and so forth, in addition to a gain. As a part of performing an operation for receiving a radio signal in the wireless transmission device, a composition of a single super-heterodyne method is presented. However, other methods such as a straight method, a double super-heterodyne method, and a triple super-heterodyne method may be used. Also, the wireless transmission device may be replaced by a monolithic integrated circuit, a circuit comprised of individual parts, or a module.

According to the wireless transmission device according to the present invention as explained above, a reception parameter is written into the reception parameter memory means for renewal only when a predetermined renewal condition for the predetermined reception parameter is satisfied. Since circuit characteristics such as a gain remain unchanged while receiving a radio signal, occurrences of distortion and an error in a signal which is being received can be prevented. Also, the sending parameter is written into the sending parameter memory means for renewal only when a predetermined renewal condition for a sending parameter is satisfied. Since the circuit characteristics such as a gain remain unchanged while sending the radio signal, occurrences of distortion and an error in the radio signal which is being sent can be prevented.

This application is based on a Japanese Patent Application No. 2007-223966 which is hereby incorporated by reference.

What is claimed is:

1. A wireless reception device for generating a reception parameter and controlling its characteristic on the basis of a generated reception parameter, comprising:
reception means for receiving a radio signal by a reception characteristic which corresponds to a reception characteristic control signal;
reception parameter generating means for generating said reception parameter;
reception parameter memory means for storing said reception parameter;
reception parameter writing means for writing a reception parameter which is generated by said reception parameter generating means into said reception parameter memory means for renewal so as to renew said reception parameter; and
reception control means for generating said reception characteristic control signal on the basis of a reception parameter which is stored in said reception parameter memory means,
wherein said reception parameter writing means writes said reception parameter into said reception parameter memory means for renewal only when a predetermined renewal condition for a reception parameter is satisfied.

2. The wireless reception device according to claim 1, wherein said predetermined renewal condition for a reception parameter is that the radio signal is not being received by said reception means.

3. The wireless reception device according to claim 2, wherein said renewal condition for a reception parameter includes that a period more than a minimum renewal interval has elapsed since a previous renewal of a reception parameter.

4. A wireless sending device for generating a sending parameter and controlling its characteristic on the basis of a generated sending parameter, comprising:
sending means for sending a radio signal by a sending characteristic which corresponds to a sending characteristic control signal;
sending parameter generating means for generating said sending parameter;
sending parameter memory means for storing said sending parameter;
sending parameter writing means for writing a sending parameter which is generated by said sending parameter generating means into said sending parameter memory means for renewal; and
sending control means for generating said sending characteristic control signal on the basis of a sending parameter which is stored in said sending parameter memory means,
wherein said sending parameter writing means writes said sending parameter into said sending parameter memory means for renewal only when a predetermined renewal condition for a sending parameter is satisfied.

5. The wireless sending device according to claim 3, wherein said predetermined renewal condition for the sending parameter is that a radio signal is not being sent by said sending means.

6. The wireless sending device according to claim 5, wherein said renewal condition for the sending parameter includes that a period more than a minimum renewal interval has elapsed since a previous renewal of a reception parameter.

7. A wireless transmitting device having: a wireless reception device for generating a reception parameter and controlling its characteristic on the basis of the generated reception parameter; and a wireless sending device for generating a sending parameter and controlling its characteristic on the basis of the generated sending parameter,
wherein said wireless reception device comprising: reception means for receiving a radio signal by a reception characteristic which corresponds to a reception characteristic control signal; reception parameter generating means for generating said reception parameter; reception parameter memory means for storing said reception parameter; reception parameter writing means for writing a reception parameter which is generated by said reception parameter generating means into the reception parameter memory means for renewal; and reception control means for generating said reception characteristic control signal on the basis of a reception parameter which is stored in said reception parameter memory means,
wherein said wireless sending device includes: sending means for sending a radio signal by a sending characteristic which corresponds to a sending characteristic control signal; sending parameter generating means for generating said sending parameter; sending parameter memory means for storing said sending parameter; sending parameter writing means for writing the sending parameter which is generated by said sending parameter generating means into said sending parameter memory mean for renewal; and sending control means for generating said sending characteristic control signal on the basis of a sending parameter which is stored in said sending parameter memory means,
wherein said reception parameter writing means writes said reception parameter into said reception parameter memory means for renewal only when a predetermined renewal condition for the reception parameter is satisfied, and
wherein said sending parameter writing means writes said sending parameter into said sending parameter memory means for renewal only when a predetermined renewal condition for the sending parameter is satisfied.

8. The wireless transmission device according to claim 7, comprising: said predetermined renewal condition for the reception parameter is that a radio signal is not being received by said reception means.

9. The wireless reception device according to claim 8, wherein said renewal condition for the reception parameter includes that a period more than a minimum renewal interval has elapsed since a previous renewal of a reception parameter.

10. The wireless transmission device according to claim 9, wherein said predetermined renewal condition for the sending parameter is that a radio signal is not being sent by said sending means.

11. The wireless transmission device according to claim 10, wherein said renewal condition for the sending parameter includes that a period more than a minimum renewal interval has elapsed since a previous renewal of a sending parameter.
